(19) United States
(12) Patent Application Publication
(10) Pub. No.: US 2011/0020163 A1
(43) Pub. Date: Jan. 27, 2011

(54) Super-Hard Enhanced Hard Metals

(76) Inventor: Roger William Nigel Nilen, Springs (ZA)

Correspondence Address: FROMMER LAWRENCE & HAUG, 745 FIFTH AVENUE- 10TH FL., NEW YORK, NY, 10151, US

(21) Appl. No.: 12/919,800

(22) PCT Filed: Apr. 15, 2009
(86) PCT No.: PCT/IB09/51567

§ 371 Date: Oct. 15, 2010

(30) Foreign Application Priority Data
Apr. 15, 2008 (GB) 0806839.7

(51) Int. Cl. B22F 3/12; B32B 15/02

(52) U.S. Cl. 419/10; 75/230; 75/243; 75/236; 75/232; 75/244; 75/240; 75/238; 75/233; 75/239

(57) ABSTRACT

The present invention relates to a super-hard enhanced hard-metal comprising particulate hard material and a binder and at least one formation, the formation comprising a core cluster and a plurality of satellite clusters, spaced from, surrounding and smaller than the core cluster, and the core cluster and satellite clusters each comprising a plurality of contiguous super-hard particles. The invention further relates to a method for making a super-hard enhanced hard-metal, the method including forming a green body comprising super-hard particles, particles of a hard material and at least one binder material or material that is capable of being converted into a binder material; subjecting the green body to a temperature of at least 500 degrees centigrade and a pressure at which the super-hard material is not thermodynamically stable to form a sintered body; and subjecting the sintered body to a pressure and temperature at which the super-hard material is thermodynamically stable and to inserts for tools comprising the enhanced hard-metal.

### INTRODUCTION

This invention relates to hard-metals enhanced with super-hard material and a method for their manufacture.

### BACKGROUND TO THE INVENTION

A hard-metal is understood to be a type of material that comprises particles of a ceramic material, such as tungsten carbide, held together by a metal or metal alloy, typically including cobalt, iron or nickel. Cobalt-cemented tungsten carbide is a common type of hard-metal. Hard-metals are widely used for machining, cutting, drilling or degrading work-pieces or bodies comprising hard or abrasive materials, or for components that may be subject to abrasive wear in use.

A super-hard enhanced hard-metal is understood to mean a composite material that comprises particles of diamond or other super-hard material and particles of a hard material, wherein these particles are held together by means of a binder, preferably a metallic binder.

U.S. Pat. No. 5,453,105 discloses a method of producing an abrasive product, the method comprising providing a mixture of diamond and discrete carbide particles, the diamond particles being smaller than the carbide particles and present in the mixture in an amount of more than 50 percent by volume, and subjecting the mixture to elevated temperature and pressure conditions at which diamond is crystallographically stable in the presence of a binder metal capable of bonding the mixture into a hard conglomerate.

U.S. Pat. No. 5,889,219 discloses a composite member that contains a hard material of at least one element selected from a group of WC, TiC, TiN and Ti(C, N), a binder material consisting of an iron family metal and diamond grains, which are formed by direct resistance heating and pressurized sintering.

U.S. Pat. No. 7,033,408 discloses a method of producing an abrasive product comprising: (1) providing a mixture of a mass of discrete carbide particles and a mass of diamond particles, the diamond particles being present in the mixture in an amount such that the diamond content of the abrasive product is 25% or less by weight; and (2) subjecting the mixture to elevated temperature and pressure conditions at which the diamond is crystallographically stable and at which substantially no graphite is formed, in the presence of a bonding metal or alloy capable of bonding the mixture into a coherent, sintered product, to produce the abrasive product.

There is a need to provide a hard-metal enhanced with diamond or other super-hard particles, the enhanced hard-metal having substantially enhanced mechanical properties. A further need exists for a method of making such an enhanced hard-metal.

### SUMMARY OF THE INVENTION

According to a first aspect of the invention there is provided a super-hard enhanced hard-metal comprising particulate hard material and a binder material and at least one formation, the formation comprising a core cluster and a plurality of satellite clusters, spaced from, surrounding and smaller than the core cluster, and the core cluster and satellite clusters each comprising a plurality of contiguous super-hard particles.

The term “contiguous” is intended to encompass bonded, intergrown or simply in contact.

Preferably the super-hard particles comprise diamond.

Preferably each satellite cluster has an average volume of less than about 20% that of the core cluster, more preferably each satellite cluster has an average volume of less than about 10% that of the core cluster.

Preferably each satellite cluster contains fewer than about 20% of the number of super-hard particles contained within the core cluster, more preferably each satellite cluster contains fewer than about 10% of the number of super-hard particles contained within the core cluster.

A hard-metal is understood to be a type of material that comprises particles of a ceramic material, such as tungsten carbide, held together by a metal or metal alloy, typically including cobalt, iron or nickel (binder material). Cobalt-cemented tungsten carbide is a preferred type of hard-metal.

The term “super-hard” used in relation to a material is understood to mean that the material has a hardness of at least 30 GPa. Diamond and cubic boron nitride (cBN) are examples of super-hard material.

The term “hard” used in relation to a material is understood to mean that the material has a hardness in the range between about 15 GPa to less than 30 GPa. Tungsten carbide and titanium carbide are examples of hard material.

Preferably the core cluster comprises a plurality of super-hard particles and hard material particles.

In a preferred embodiment of the invention, the core cluster comprises a collar or shell of super-hard particles and hard material enclosing a region containing binder material and substantially less super-hard material, or substantially free of super-hard particles. Preferably the binder material within the region is rich in carbon. The term “rich in carbon” means relatively more carbon than the average in the rest of the binder, but still less than the thermodynamic carbon solubility level. Alternatively, the core cluster may comprise a super-hard particle directly bonded to a collar or shell of super-hard particles and hard material.

Preferably the hard material comprises a metal carbide, metal oxide or metal nitride, boron sub-oxide or boron carbide, more preferably a metal carbide and even more preferably selected from the group consisting of WC, TiC, VC, Cr₃C₂, Cr₇C₃, ZrC, Mo₂C, HfC, NbC, Nb₂C, TaC, Ta₂C, W₂C, SIC and Al₄C₃. Most preferably, WC or TiC is present as a hard material.

According to the present invention there is provided a super-hard enhanced hard-metal comprising a plurality of formations dispersed through the hard-metal.

Preferably the binder material is a metal or metal alloy containing one or more of cobalt, iron or nickel. The binder material may additionally comprise an inter-metallic material, such as Ni₃Al, Ni₂Al₃ and NiAl₃, CoSn, NiCrP, NiCrB and NiP. Most preferably the binder material comprises Co or Ni, or both Co and Ni. The volume content of the binder material in the final sintered article is preferably within the range 1 to 40 volume %. More preferably, the binder material is present at between 5 and 20 volume %, and most preferably between 5 and 15 volume %.

Preferably the core cluster is at least twice the average size of each satellite cluster. Average size may be determined by measuring the largest diameter of any cluster.

The super-hard particles are preferably within the size range from about 0.1 to about 5,000 micrometers, more preferably within the size range from about 0.5 to about 100 micrometers, and most preferably within the size range from about 0.5 to about 20 micrometers (um or μm).

Preferably the content of super-hard material within the super-hard enhanced hard-metal is in the range from 20 to 60 volume percent (%).

The hard material particles are preferably within the size range from about 0.5 to about 100 micrometers, more preferably within the size range from about 0.5 to about 20 micrometers.

Preferably the content of hard material within the super-hard enhanced hard-metal is in the range from 20 to 80 volume percent, and more preferably in the range from 40 to 80 volume percent. It is known in the art that the grain (particle) size of the hard material may be selected to optimise performance of the sintered article in particular given applications (for example coarser particles are generally used more for mining applications than for metal cutting applications).

The formations preferably have a substantially isotropic character.

Preferably the super-hard enhanced hard-metal has substantially no graphite present.

The core cluster may contain a remnant of an original diamond (or other super-hard) particle as incorporated within a green body as utilised in the production of the hard-metal, or it may comprise the binder material with few or no diamond (or other super-hard) particles, or it may comprise a dense cluster of diamond (or other super-hard) particles, which may be substantially contiguous (or inter-grown) to form a coherent mass. Clusters surrounding the core cluster preferably comprise densely clustered diamond (or other super-hard) particles, which may be substantially inter-grown.

The clusters of super-hard particles may incorporate crystallised particles of the hard material. In the case where WC is present, in the raw materials, recrystallised WC particles are likely to be present within or in close proximity to the diamond (or other super-hard) clusters. Where such crystallised hard material particles are present within or closely proximate to clusters of super-hard particles, they may contact or be interconnected with one or more of the super-hard particles.

The scale of the diameter of the core cluster is typically greater than the diameter of the original super-hard particle from which it arose. There will typically be several such formations in close proximity to each other and they may spatially overlap.

Super-hard enhanced hard-metals according to the invention have enhanced hardness and abrasive wear resistance, making such enhanced hard-metals more effective in high wear rate applications such as cutting hard or abrasive materials (for example rock, wood and composites). The materials may have enhanced toughness as well as enhanced hardness. It is expected that enhanced hard-metals may be used in many applications in which conventional hard-metals are used.

According to a second aspect of the invention there is provided a method for making a super-hard enhanced hard-metal, the method including forming a green body comprising super-hard particles, particles of a hard material and at least one binder material or material that is capable of being converted into a binder material; subjecting the green body to a temperature of at least 500 degrees centigrade and a pressure at which the super-hard material is not thermodynamically stable to form a sintered body; and subjecting the sintered body to a pressure and temperature at which the super-hard material is thermodynamically stable. Preferably the super-hard enhanced hard-metal so produced is according to the first aspect of the invention described above.

It will be understood that the preferred or typical examples of superhard particles, hard material, binder and relative quantities as hereinbefore set out for the first aspect of the invention, apply also to this aspect of the invention.

The step of subjecting the green body to a temperature of at least 500 degrees centigrade and a pressure at which the super-hard material is not thermodynamically stable may be referred to as “conventional sintering”.

The step of subjecting a body to a pressure and temperature at which the super-hard material is thermodynamically stable may be referred to as “ultra-high pressure sintering”. Where the body contains diamond, the ultra-high pressure sintering step involves subjecting the body to a pressure of at least about 3 GPa, more preferably to at least 5 GPa.

The super-hard material is wholly or partly converted into a soft material during the conventional sintering step and then substantially wholly reconverted into the super-hard material during the ultra-high pressure sintering step. This process results in the transformation of a single original super-hard particle incorporated within the green body, into a formation within the finished super-hard enhanced hard-metal, as described above.

The term “green body” is known in the art and is understood to refer to an article intended to be sintered, but which has not yet been sintered. It is generally self-supporting and has the general form of the intended finished article. A green body is typically formed by combining a plurality of particles in a vessel and then compacting them to form a self-supporting article.

The super-hard particles may be uncoated or coated, and are preferably uncoated. Where the super-hard material is diamond, coating of the diamond particles may be used to limit and control the degree and rate of diamond conversion to graphite. A coating may additionally or alternatively comprise a component for promoting sintering. The shape, quality, thermal stability, inclusion content and other properties of the super-hard particles may be selected to achieve optimal properties of the super-hard enhanced hard-metal for particular applications.

The heat treatment of the green body (an aspect of conventional sintering) is preferably carried out under an applied pressure of less than 300 MPa, and preferably at a temperature of greater than 1,000 degrees centigrade, more preferably greater than the melting point of the binder material, and most preferably under conditions suitable for achieving inter-particle sintering between the hard material particles. Any of the sintering approaches known in the art may be used at this stage, such as vacuum sintering, hot isostatic pressing (HIP), spark plasma sintering (SPS), microwave sintering and induction furnace sintering.

The method involves the deliberate complete or partial conversion of a super-hard material into a soft material. Where the super-hard material comprises diamond, the method involves the conversion of diamond into graphite, (a process known as graphitisation). An advantage of the method is that it is easier to blend super-hard particles with hard material particles than it is to blend soft-material particles, and consequently to achieve a more homogeneous mixture and a more homogeneous distribution of super-hard particles within the enhanced hard-metal. A further advantage is that distortion of the formations during pressurisation is substantially avoided, thereby minimising the formation of formations that tend to create stress fields within the final sintered product. A further advantage is that the hard particles are sintered under optimal conditions for extended periods of time during the conventional sintering step, as is generally required for optimal sintering. Where the super-hard material comprises diamond, a further advantage is that the graphite formations arising from the sintering step are in a form suitable for controlled reconversion into diamond during the stage of subjecting the sintered body to a pressure and temperature at which the super-hard material is thermodynamically stable. A further advantage is that porosity within the sintered body subjected to ultra-high pressure sintering is substantially less than that within the green body. This has the significant advantage that less pressure may be required to form the final product, which typically results in an economic benefit.

Additional advantages of the method according to the present invention arise from the fact that the ultra-high pressure sintering step is typically much shorter than conventional sintering used for manufacturing hard-metals. Conventional sintering cycles are typically several hours long in order to achieve the desired microstructures and properties. It would be uneconomical to subject super-hard enhanced hard-metal articles at ultra-high pressure sintering for longer than several minutes, since far fewer articles can be sintered within an ultra-high pressure furnace vessels than can be sintered within a conventional furnace. Consequently, the method provides for optimal sintering of the hard-metal by maintaining high temperatures for an extended period of time during the conventional sintering step. The subsequent ultra-high pressure sintering step minimises the risk of residual soft material, such as graphite, remaining within the sintered article.

The method also minimises the material volume collapse during ultra-high pressure sintering and provides more control and a range of options for incorporating excess carbon into the green body.

According to a third aspect of the invention there is provided an insert for a tool, the insert comprising a super-hard enhanced hard-metal according to the first aspect of the invention. Preferably the tool is for cutting, machining, drilling, milling or degrading of a work-piece or body comprising an abrasive or hard material such as wood, ceramic, cermet, super-alloy, metal, rock, concrete, stone, asphalt, masonry and composite materials. Preferably the tool is a ground-engaging tool for boring into rock, as in the oil and gas drilling industry, or an attack tool for pavement degradation or soft rock mining.

### DRAWING CAPTIONS

Non-limiting preferred embodiments will now be described with reference to the following figures of which:

FIGS. 1 to 3 show schematic diagrams of embodiments of three different versions of formations of super-hard and hard particles within super-hard enhanced hard-metals, as well as the same regions of the hard-metals prior to ultra-high pressure sintering.

FIG. 4 is an X-ray diffraction (XRD) analysis of DEC material according to Examples 1-4, scaled to the graphite peak region of the XRD diffractogram;

FIG. 5 is an XRD analysis of DEC material according to Example 1-4, scaled to the diamond peak region of the XRD diffractogram;

FIG. 6 is a scanning electron microscope (SEM) micrograph of the post-conventional sintering/pre-hphT sintering DEC material according to Example 1;

FIG. 7 is an SEM micrograph of the post-hphT sintering DEC material according to Example 1;

FIG. 8 is an SEM micrograph of the post-hphT sintering DEC material according to Example 2;

FIG. 9 is another SEM micrograph of the post-hphT sintering DEC material according to Example 2;

FIG. 10 is an SEM micrograph of the post-hphT sintering DEC material according to Example 3;

FIG. 11 is another SEM micrograph of the post-hphT sintering DEC material according to Example 3;

FIG. 12 is another SEM micrograph of the post-hphT sintering DEC material according to Example 3;

FIG. 13 is an SEM micrograph of the post-conventional sintering/pre-hphT sintering DEC material according to Example 4;

FIG. 14 is an SEM micrograph of the post-hphT sintering DEC material according to Example 4;

FIG. 15 is another SEM micrograph of the post-hphT sintering DEC material according to Example 4;

FIG. 16 is another SEM micrograph of the post-hphT sintering DEC material according to Example 4;

FIG. 17 provides a summary of the microstructural features of the invention, both as micrograph images and schematic representations, corresponding to added diamond grains in the size ranges of less than 70 microns, approximately 70 microns and greater than 70 microns.

FIG. 18(a) shows a photograph of an article following conventional carbide sintering, the article containing cemented WC and non-diamond carbon representing 5 wt. % of the article, the non-diamond carbon having been introduced as graphite powder into the starting powder mix. Cracks are clearly visible in the sintered article.

FIG. 18(b) shows a photograph of an article following conventional carbide sintering, the article containing cemented WC and non-diamond carbon representing 5 wt. % of the article, the non-diamond carbon having been introduced as diamond powder into the starting powder mix. The sintered article is substantially crack-free and denser than the article of FIG. 18(a).

FIG. 19 shows a graph of elastic modulus, or Young's modulus, of cemented tungsten carbide articles of the same geometry. In all but the control article, 7.1 wt. % diamond powder had been introduced into the starting powder mix to yield articles comprising diamond grains dispersed throughout the cemented carbide, following a first step involving conventional carbide sintering and a second step involving sintering at hphT conditions. The graph shows that, even though diamond content is that same for all but the control article, the Young's modulus of the material increases as the added diamond grains increase in average size from about 2 to about 70 microns. The Young's modulus of the control cobalt-cemented WC article, wherein the cobalt was present at about 13 wt. %, was about 558±5 GPa, and those of the articles with two, twenty and seventy micron diamond was about 580, 595 and 660, respectively.

FIG. 20 shows a graph of the measured average Young's modulus of a set of conventional cemented tungsten carbide grade, comprising 6 wt. % cobalt and the 94 wt. % tungsten carbide grains with an average size of between 1 and 3 microns, and samples comprising the same cemented carbide formulation, but enhanced with diamond at content of about 9 wt. % according to the invention. The graphs shows the average Young's modulus of two sets of diamond-enhanced samples, made by introducing diamond grains of two different average size distributions into the starting powder, the respective average sizes being about 2 and 30 microns. The Young's modulus of the conventional, control carbide grade is approximately 629±2 GPa, and that of the both the diamond-enhanced materials is about 712±5 GPa. The graph also shows the Young's moduli predicted by the “geometric” theoretical model, which are in excellent agreement with the measured values.

FIG. 21 shows the strengths of the materials of FIG. 20. The strength of the conventional carbide used as an experimental control is 2.5±0.1 GPa. The respective average strengths of the two sets of samples of diamond-enhanced samples made according to the invention are 2.2 and 1.9±0.15 GPa.

FIG. 22 shows a graph of the wear resistance of diamond enhanced carbide vs conventional carbide in terms of Example 8.

### DESCRIPTION OF EMBODIMENTS

In a first embodiment described with reference to FIG. 1, a hard-metal microstructure, 200, comprises particles of refractory metal carbide, 210, and clusters, 220 and 260, of diamond particles dispersed within a binder, 230, comprising an iron group metal or metal alloy. The diamond particles are arranged in a formation comprising a core cluster, (C shown in FIG. 8 et seq.), surrounded by relatively substantially smaller satellite clusters, 220. The core cluster comprises a cluster of contiguous diamond particles, 260, with particles of the refractory metal carbide, 250, interspersed among them. Some of the recrystallised diamond particles, especially those close to the core cluster, may be substantially inter-grown, forming PCD (polycrystalline diamond) particles within which recrystallised hard-material particles are also likely to be present. A core cluster of this kind is hereafter referred to as polycrystalline diamond carbide (PCDC), and the type of formation as a whole is hereafter referred to as “PCDC granule with PCDC satellites”. The SEM micrograph of a polished section of a hard-metal, shown in FIG. 8, shows an example of a diamond cluster formation according to this embodiment.

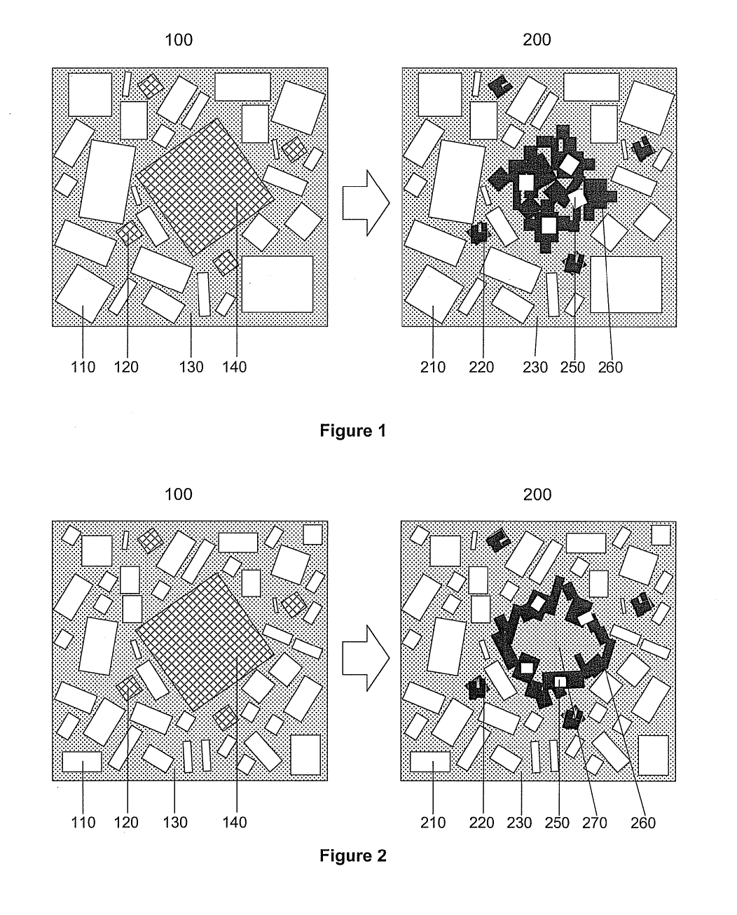

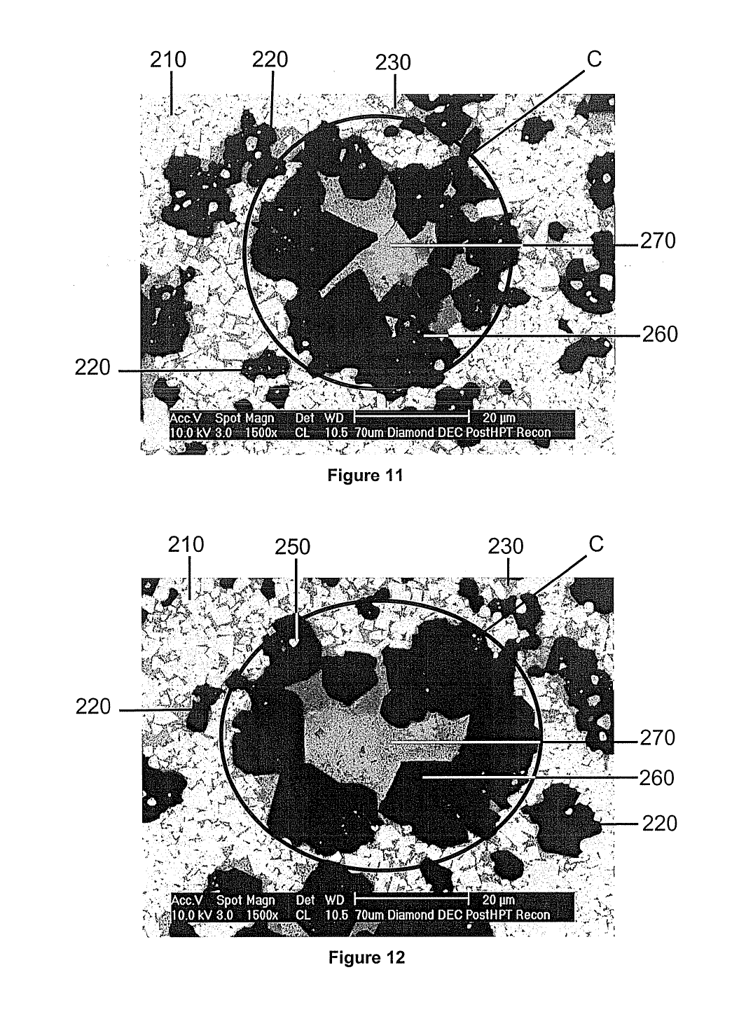

In a second embodiment described with reference to FIG. 2, the core cluster in cross-section has the appearance of a collar, 260, of clustered diamond particles, generally enclosing or encircling a central region, 270, containing substantially less diamond than the collar, or is substantially devoid of diamond. In three dimensions, the diamond clusters within the core cluster has the general appearance of a shell surrounding the central region. This kind of formation is hereafter referred to as a “PCDC-collared binder pool”. The SEM micrographs of a polished section of a hard-metal, shown in FIGS. 11 and 12, show examples of diamond cluster formations according to this embodiment.

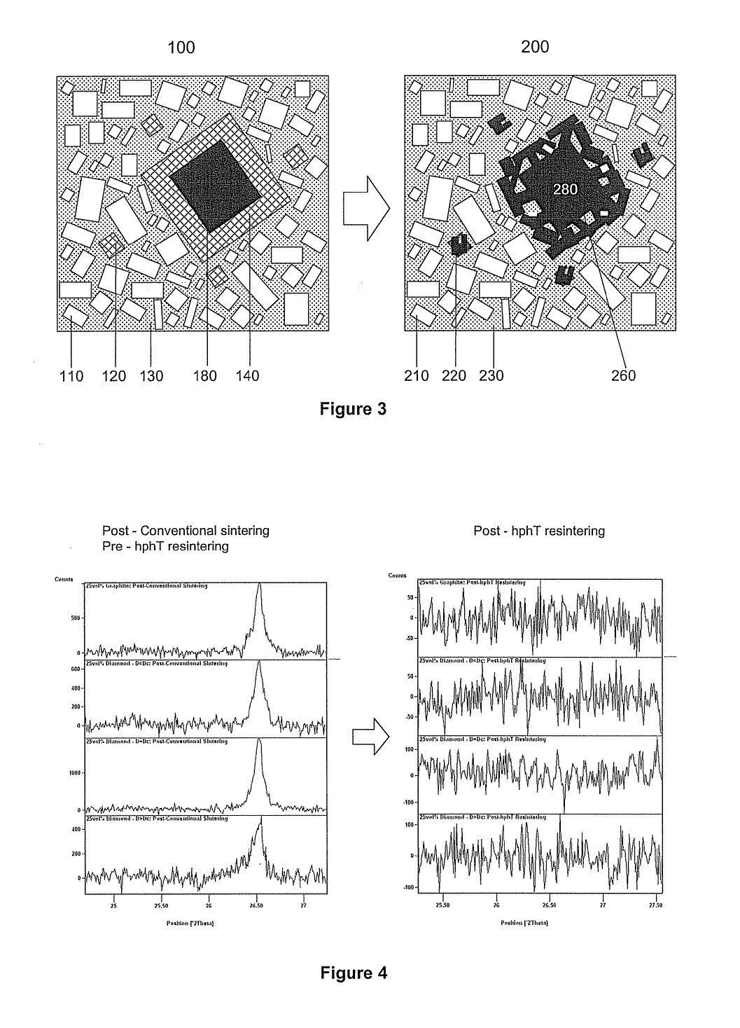

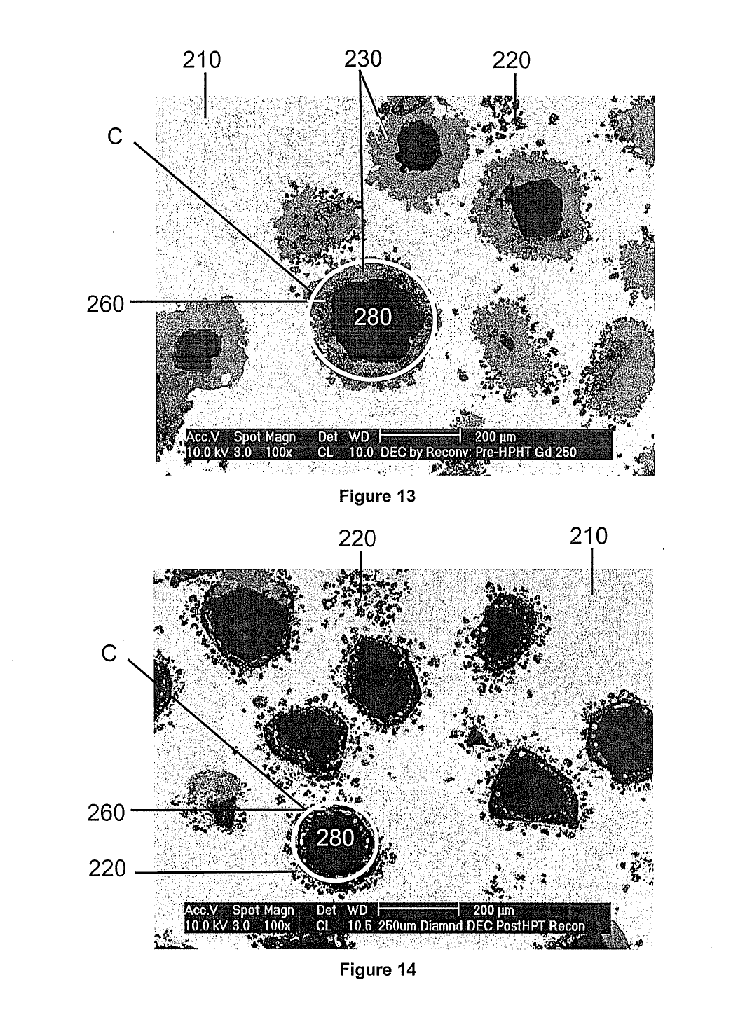

In a third embodiment described with reference to FIG. 3, the core cluster comprises a central, relatively large diamond crystal, 280, surrounded by a shell, 260, of relatively smaller clusters of diamond particles to which it is bonded. In cross-section, the shell, 260, has the appearance of a collar. This type of formation is hereafter referred to as a “PCDC-collared diamond”. Without wishing to be bound to any theory, it is believed that this PCDC collar significantly reduces stress concentration at the sharp corners formed by the intercepting facets typical of large diamond grains, thereby increasing the impact resistance of the composite material. The SEM micrographs of a polished section of a hard-metal, shown in FIGS. 13 and 16, show examples of diamond cluster formations according to this embodiment.

The super-hard enhanced hard-metal is manufactured by blending super-hard particles of diamond or cBN with particles of a hard material, such as tungsten carbide, as well as particles of a suitable binder material, such as cobalt. Alternatively, precursor materials suitable for subsequent conversion into a hard material or binder material may be incorporated into the blend. Alternatively, the binder material may be incorporated in a form suitable for infiltration into the green body during the first sintering stage. Any effective powder preparation technology can be used to blend the powders, such as wet or dry multidirectional mixing (Turbula), planetary ball milling and high shear mixing with a homogenizer. For diamonds larger than about 50 micrometers, simply stirring the powders together by hand is also effective. A green body is then formed by compacting the powders. The green body may be formed by means of uniaxial powder pressing, or any of the other compaction methods known in the art, such as cold isostatic pressing (CIP).

The green body is then subjected to any of the sintering processes known in the art to be suitable for sintering similar materials without the presence of diamond (i.e. a conventional hard-metal sintering process). During this stage the diamond or cBN particles wholly or partially convert to the low pressure phase, which in the case of diamond is graphite or other forms of carbon, and in the case of cBN is hexagonal boron nitride (hBN). The extent of graphitisation of the added diamonds depends on, for example, the type, size, surface chemistry and possible coating of the diamond, as well as the sintering conditions and binder material content and chemistry.

After the conventional sintering step, the sintered article is subjected to a second sintering step at an ultra-high pressure at which diamond is thermally stable. An ultra-high pressure furnace well known in the art of diamond synthesis and sintering is used to subject the sintered article to a pressure of at least 5 GPa and a temperature of at least 1300 degrees centigrade. Under these conditions, the low pressure phase of diamond or cBN, as the case may be, that arose during the conventional sintering step transforms back, or “recystalises” into the high pressure phase, namely diamond or cBN.

The size of the diamond particles added to the powder mix and hence the green body affects the nature of the size and spatial distribution of the recrystallised diamonds in the final sintered product. The process disclosed herein results in several unique and new spatial distribution formations that are substantially spherically symmetric. For any given low pressure heat treatment regime, there exists a critical diamond grain size, D_{C}, below which the entire diamond particle converts to graphite, and above which a core of diamond remains after the heat treatment, surrounded by a graphite-rich zone. The term ‘grain size’ refers herein to the length of the longest dimension of the grain. Three qualitatively different recrystallised diamond formations arise within the final sintered product corresponding to where i) the added diamond grain size (D) is less than D_{C}, ii) D is approximately equal to D_{C}, and iii) D is greater than D.

The relationship between the size of the diamond particle incorporated within the green body and the version of formation of diamond clusters in the finished enhanced hard-metal can be understood with reference to FIGS. 1 to 3. In each figure, the region, 100, within the hard-metal sintered body (i.e. the directly after the green body has been subjected to the conventional sintering step) corresponding to the region, 200, of the finished product containing the formation of diamond clusters is shown schematically. In other words, the figures show schematically how a formation of super-hard particles arises from a corresponding formation prior to the ultra-high pressure sintering step.

In FIGS. 1 and 2, the region, 100, within the sintered body contains no diamond, all of the diamond incorporated within the green body having transformed into graphite during the conventional sintering step. Multiple graphitic structures, 120 and 140, arise from precipitation of carbon liberated by the dissolution of a single diamond particle (not shown). In this embodiment, the size of the diamond grain was sufficiently. small -that the entire diamond particle dissolved and converted into graphite during the conventional sintering step. FIGS. 1 and 2 correspond to embodiments in which D is less than D_{C}, and D is equal to D_{C}, respectively. In these embodiments, the graphitic structures form as a plurality of graphitic particles, 120, surrounding a relatively much larger graphite core, 140. The carbide particles, 110, and the metallic binder, 130, are also schematically shown.

In FIG. 3, the region, 100, within the sintered body contains a remnant of the original diamond particle which did not wholly dissolve during the conventional sintering step, because it was sufficiently large, with D substantially greater than D. The diamond core, 180, is surrounded by a shell or collar of precipitated graphite, 140, which arose from the partial dissolution of the diamond particle. Additional smaller graphite precipitates, 120, also arise in the region surrounding the core. The carbide particles, 110, and the metallic binder, 130, are also schematically shown.

As a guide, it was found that D_{C} may be in the region of 70 micrometers in an embodiment wherein the hard-metal comprised tungsten carbide particles dispersed within about 7.5 weight percent cobalt binder. It will be appreciated that D_{C} depends on many factors, including the type of binder material, the quality of the diamond grain, and on the temperature and cycle time used for the conventional sintering step. In general, the longer the time, the higher the temperature and the worse the quality of the diamond particle, the larger will be D_{C}. The person skilled in the art will appreciate that D_{C} can be determined by means of trial and error for a given set of material and sintering parameters.

Without wishing to be bound to any theory, it is believed that the PCDC collar significantly reduces stress concentration at the sharp corners formed by the intercepting facets typical of large diamond grains, thereby increasing the impact resistance of the composite material.

Where a material is a composite of different materials, as may typically be the case for the bolster portion, the average Young's modulus, E, may be estimated by means of one of three formulas, namely the harmonic, geometric and rule of mixtures formulas, provided below as (1), (2) and (3). In these formulas, the different materials are divided into two portions with respective volume fractions of f₁ and f₂, and respective Young's moduli of Eₗ and E₂:

E=1/(f₁/E₁+f₂/E₂)) (1)

E=E₁^{f1}+E₁^{f2} (2)

E=f₁E₁+f₂E₂ (3)

where

f+f₂=1

The average Young's modulus of a material is preferably measured empirically by methods well known in the art, and the above formulas may be used as estimates.

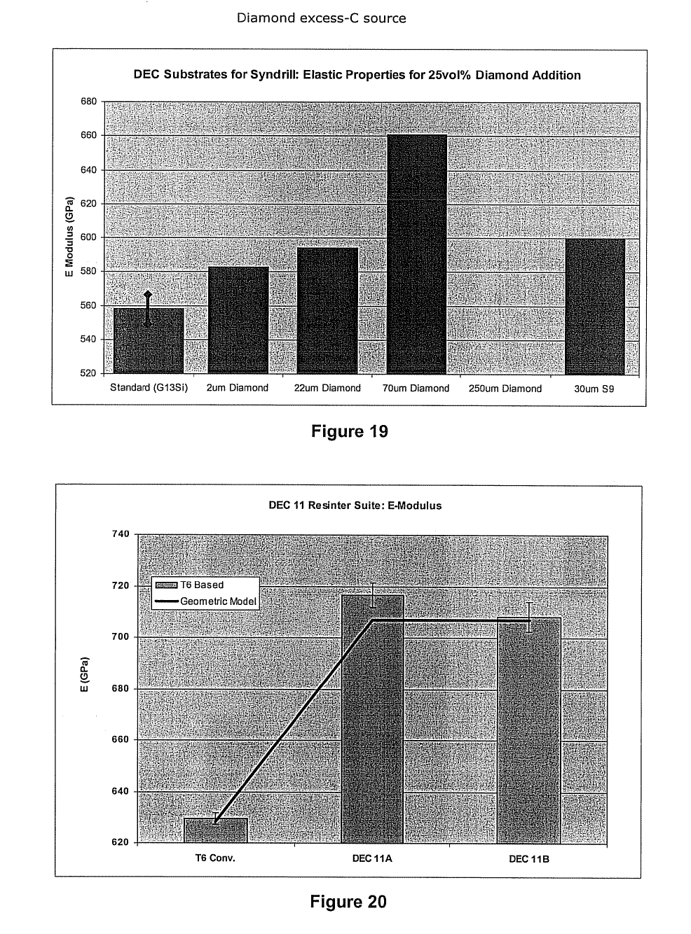

It has further been observed that the Young's modulus of diamond-enhanced carbides may tend to be higher where the diamond grains are larger. For example, as shown in FIG. 19, diamond-enhanced carbide made according to the invention with 7.5 wt % dispersed diamond grains of average size approximately 70 microns had a Young's modulus of about 660 GPa compared to about 580 GPa for a similar article comprising the same diamond content, but wherein the average size of the diamond grains was about 2 microns.

In the case of the graphite powder introduction method, the graphite powder is typically in the form of lamellae, which tend to align in a preferred orientation during axial compaction of the powders. This is may result in diamond formations having preferred orientations within the hphT sintered article as well, which may tend to increase the toughness of the article material relative to that with isotropic diamond formations. However, the graphite within the staring powders tends to result in increased elastic resilience of the powders during the initial compaction (“springback”), resulting in reduced density of the green (unsintered) article. This would be exacerbated if the graphite particles had a flaky, lamella form.

In the case of the diamond introduction method, substantially greater density of the unsintered green body is possible as compared with graphite introduction. The added diamond powder wholly or partially graphitises during the initial conventional carbide sintering phase. Typically, if the diamond grains are less than about 70 microns the entire grain volume is likely to convert to non-diamond carbon, if the grains are greater than about 70 microns only the outer region of the grains converts to non-diamond carbon, leaving diamond at the cores. As pointed out above, the critical value of the diamond grain size separating these two types of outcome would depend on several factors, which would be appreciated by the skilled person and 70 microns was found to be a typical value for the purpose of example. When the grain size is approximately of this critical value, it has been observed that the structure of the diamond formations after hphT treatment comprises recrystallised diamond grains, smaller than the introduced diamond grains, surrounding a core region comprising substantially the metallic binder phase (typically cobalt). It is believed this type of diamond formation would tend to increase the toughness of the diamond-enhanced carbide material. It is hypothesised that such formations tend to attract propagating cracks since the outer diamond-rich regions of the formation may be in a state of tension. Once the leading edge of a crack has penetrated into the formation it may be attenuated and prevented or retarded from further propagation by the metal-rich core of the formation, which may be in a state of compression. Such formations may be said to “bait and trap” cracks, thereby toughing and strengthening the material.

It is believed this type of diamond formation would tend to increase the toughness of the diamond-enhanced carbide material. It is hypothesised that such formations tend to attract propagating cracks since the outer diamond-rich regions of the formation may be in a state of tension. Once the leading edge of a crack has penetrated into the formation it may be attenuated and prevented or retarded from further propagation by the metal-rich core of the formation, which may be in a state of compression. Such formations may be said to “bait and trap” cracks, thereby toughing and strengthening the material.

### EXAMPLES

### Example 1

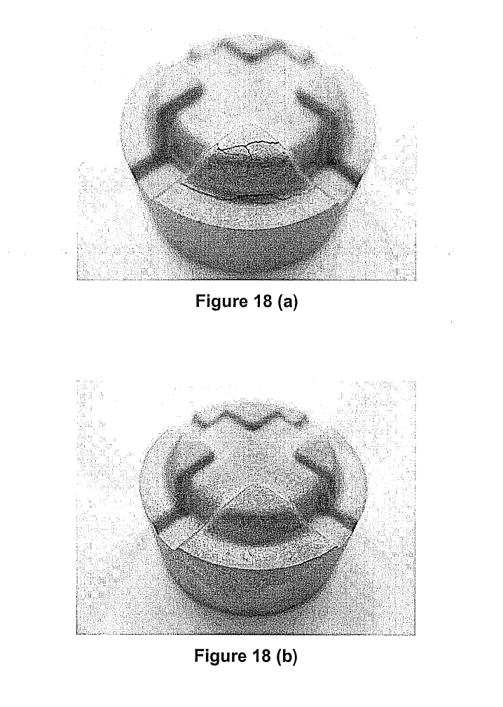

In order to assess the advantages of using diamond in the green body, as taught in the present disclosure, over the known approach of using a non-diamond carbon, two cemented carbide green bodies containing 5 wt. % non-diamond carbon were manufactured by means of a conventional powder metallurgy sintering process. The only difference between the articles was the way in which the non-diamond carbide was introduced. In one article, 5 wt. % of graphite powder was blended with 82 wt. % WC and 13 wt. % Co powder. The article was cold-compacted and then sintered in a furnace. A second article was made in the same way as the first, except that the 5 wt. % carbon was introduced as diamond powder, the grains having an average size of approximately 20 microns. By the end of the sintering process, the diamond grains had completely converted into graphite. Photographs of the two articles are shown in FIGS. 18(a) and (b). The density of the first article was approximately 87% of theoretical density, whereas that of the second article was approximately 96%. Cracks evident in the first article were not observed in the second article.

This example demonstrates that, where it is intended that a conventionally sintered carbide article comprising a significant amount of non-diamond carbide is to be subjected to hphT conditions in a subsequent step in order to convert the non-diamond carbon into diamond, it would be preferable to introduce the non-diamond carbon as diamond in the starting powder mix. This is counter-intuitive, since that diamond is converted to graphite in the conventional sintering step. Nevertheless, this approach results in denser sintered articles, which is much preferred for the hphT step to be efficient and effective, since less of the limited available pressure-induced volume collapse is wasted on compacting a lower density article, and pressure may more efficiently be generated.

### Example 2

In order to assess the advantages of using diamond in the green body, as taught in the present disclosure, over the known approach of using a non-diamond carbon, an hphT sintered compact was prepared from a sintered green body comprising graphite and no diamond.

The graphite was present at 25 volume % and had a mean grain size of approximately 30 μm. It was blended with WC powder, which had a mean grain size approximately 3 μm, together with Co powder, which was present at a level of 13 wt % (of the original carbide powder). The three powder components were blended in a methanol medium by means of a Turbula mixing apparatus for 24 hours. A green body was formed by compacting the blended and dried powders uniaxially. The green body was conventionally sintered at a temperature of 1400° C. for 2 hours (the soak time), then hphT resintered by means of a belt press at approximately 5.5 GPa, and 1400° C. for 15 minutes.

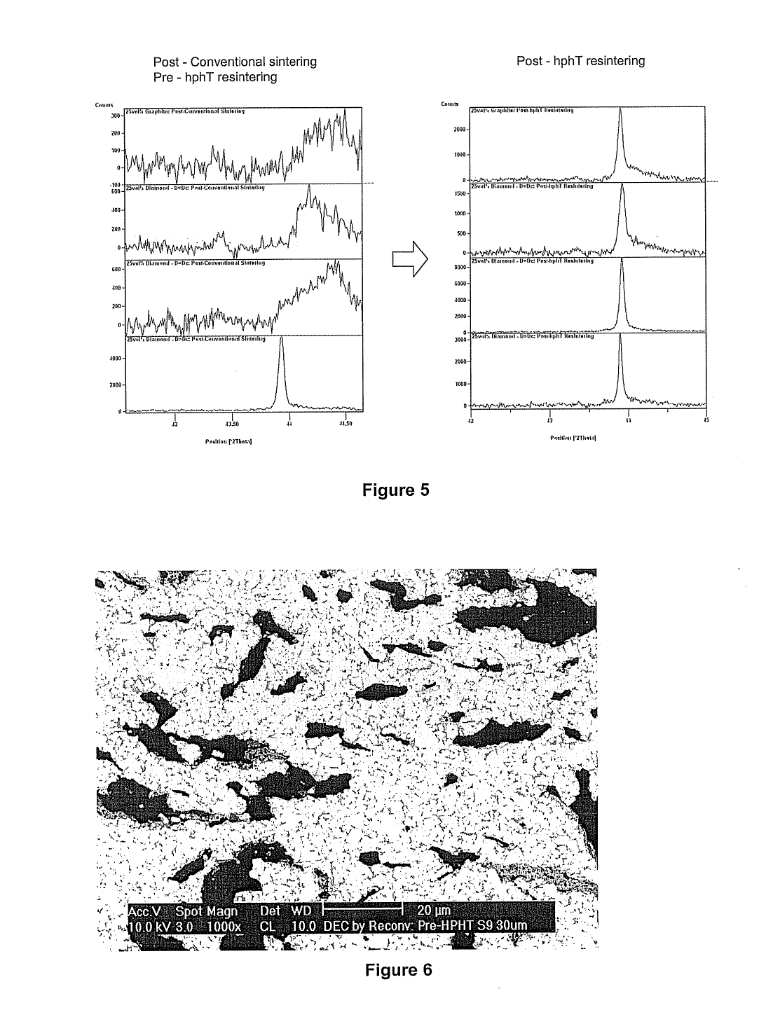

X-ray diffraction (XRD) analysis of the resintered article confirmed the incorporated graphite had reconverted to diamond (FIGS. 4-5). (FIGS. 4-5 incorporate the XRD analyses of Examples 1-4, for which the main graphite peak lies at approximately 26.5 ⁰ 2Theta, the main diamond peak at 43.9 ⁰2Theta, and the broad peak between 44-45 ⁰2Theta is due to the Co material in these materials. The diffractograms have been scaled to these particular regions for convenience.)

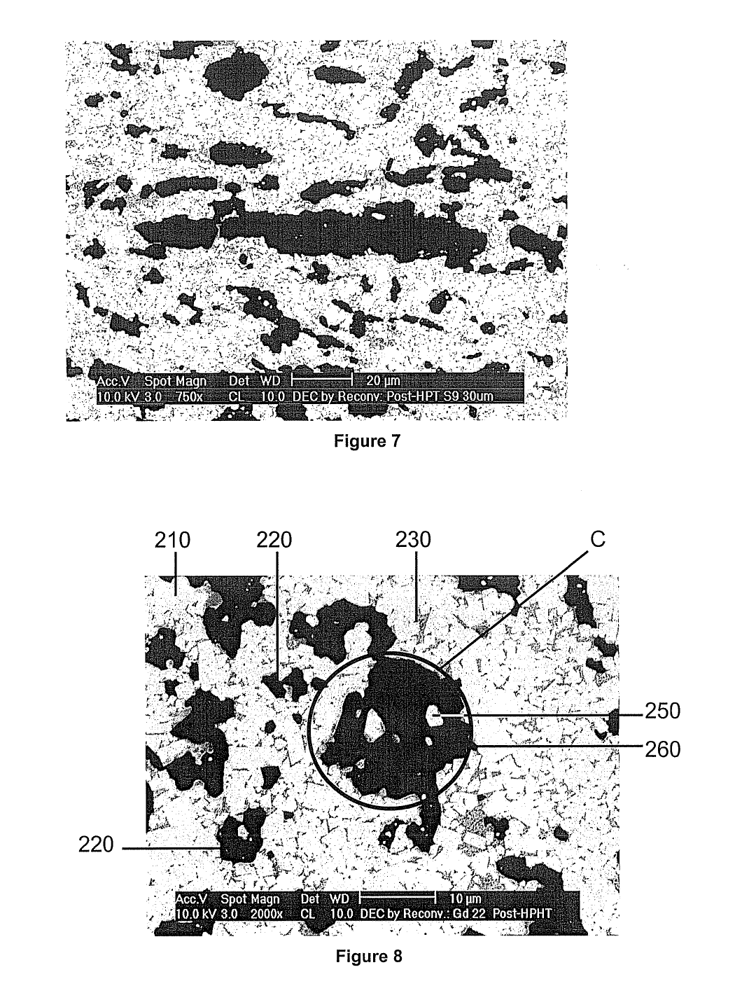

Scanning electron microscope (SEM) analysis of polished cross-sections of the material directly after the first (low pressure) sintering stage (FIG. 6) revealed graphite grain distortion and preferred orientation dominantly perpendicular to the axis of uniaxial pressing. Consequently, the PCDC formations that arose from the conversion of the graphite had a similar geometry and preferred orientation (FIG. 7), which is undesirable owing to stress concentration at the small radius of curvature edges of these high aspect ratio features. Such PCDC formations do not arise when the teachings of the present invention are followed, as exemplified below.

### Example 3 (D<D_{C})

In an example of the invention, a 25 vol % content of diamond with a mean grain size of approximately 2 μm was blended with WC powder (mean grain size approximately 3 μm) and Co powder. The Co powder was present at 13 wt % of the original carbide powder. The powders were blended, dried, compacted into a green body, conventionally sintered and hphT resintered as in Example 1.

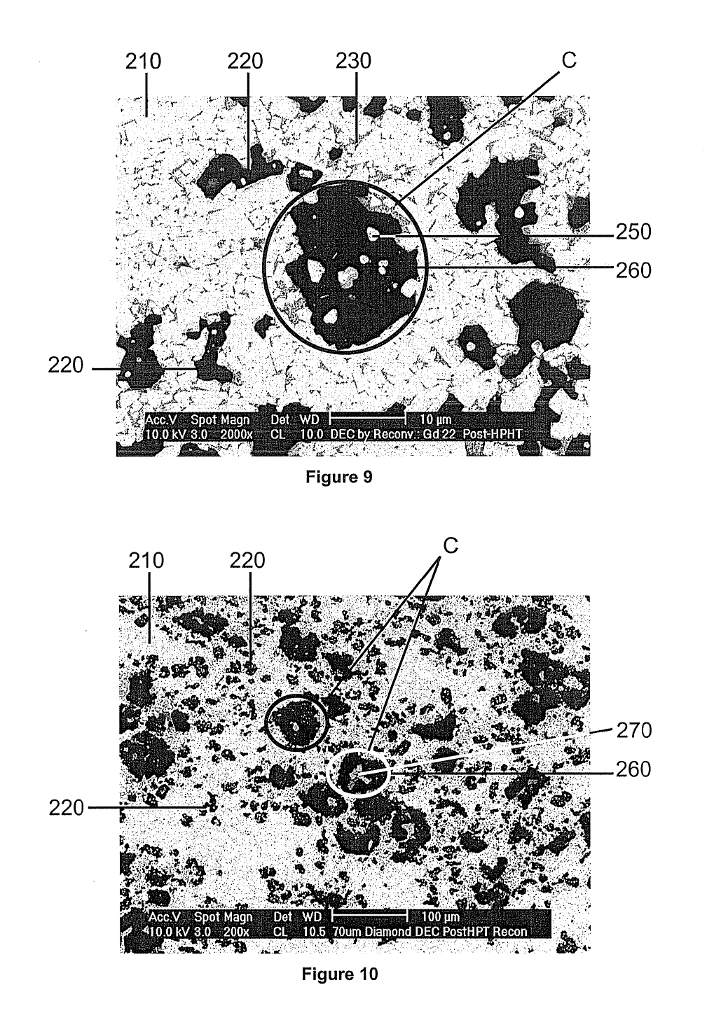

XRD analysis confirmed the full graphitisation of the incorporated diamond during conventional sintering stage and, subsequently, the full reconversion to diamond during the hphT resintering stage (FIGS. 4-5). SEM analysis of a polished cross-section of the hphT resintered material confirmed it to be a well sintered DEC without porosity (FIGS. 8-9), with a homogenous distribution of the ‘CDC granules with PCDC satellites’ microstructural feature (the feature presented schematically in FIG. 1).

### Example 4 (D≈D_{C})

In another example of the invention, a 25 vol % content of diamond with a mean grain size of approximately 70 μm was blended with WC powder, which had a mean grain size approximately 3 μm, as well as a Co powder. The Co was present at 13 wt % of the original carbide powder. The powders were blended, dried, compacted into a green body, conventionally sintered and hphT resintered as in Example 1.

XRD analysis confirmed the full graphitisation of the incorporated diamond during conventional sintering and, subsequently, the full reconversion of the graphitised diamond to diamond during hphT resintering (FIGS. 4-5). SEM analysis of a polished cross-section of the post-hphT resintered material confirmed it to be a well sintered DEC without porosity, with a homogenous distribution of the ‘CDC-collared binder pool’ microstructural feature (that presented schematically in FIG. 2). A low magnification SEM micrograph is presented in FIG. 10, with higher magnification examples of the feature given in FIGS. 11-12.

### Example 5 (D>D_{C})

In further example of the invention, a 25 vol % content of diamond with a mean grain size of approximately 250 μm was blended with WC powder, which had a mean grain size approximately 3 μm, as well as a Co powder. The Co was present at 13 wt % of the original carbide powder. The powders were blended, dried, compacted into a green body, conventionally sintered and hphT resintered as in Example 1.

XRD analysis of confirmed the partial graphitisation of the incorporated diamond during conventional sintering, with significant diamond survival (i.e. remnant diamond grains), as well as the full reconversion of the graphitised diamond to diamond during hphT resintering (FIGS. 4-5). Together with this XRD analysis, SEM analysis of a polished cross-section of the conventionally sintered material confirmed the presence of the remnant diamond grains (FIG. 13).

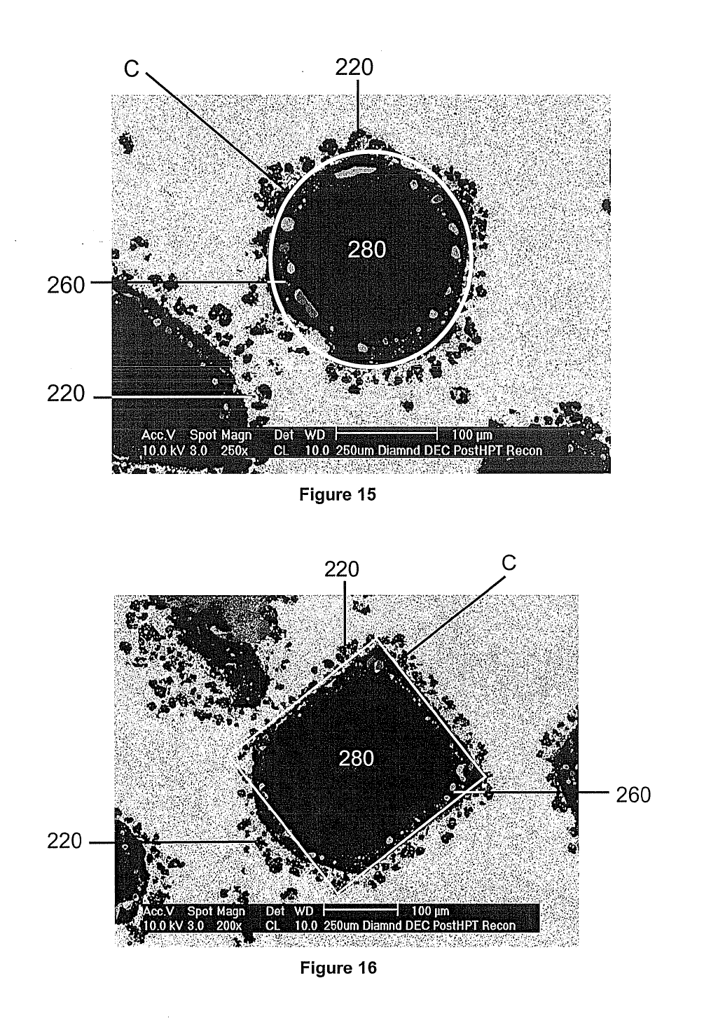

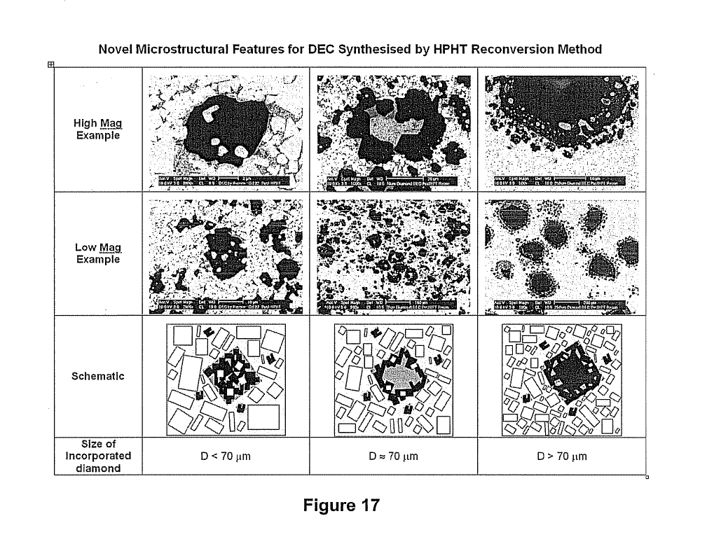

SEM analysis of a polished cross-section of the material post-hphT resintering confirmed it to be a well sintered DEC without porosity, with a homogenous distribution of the ‘CDC-collared diamond’ microstructural feature (the feature presented schematically in FIG. 3). A low magnification SEM micrograph is presented in FIG. 14, with higher magnification examples of the feature given in FIGS. 15-16.

### Example 6

Three sets of samples of diamond-enhanced cemented tungsten carbide were made according to the invention, each set consisting of seven samples. A set of control samples was made with no added diamond according to a commercially-available hard-metal formulation: approximately 87 vol. % WC and 13 wt. % cobalt. The WC was in granular form, the average size of the grains being in the range of 1 to 3 microns. The control samples were made by a process including the steps of blending the WC grains with cobalt powder, forming the powder into a green body article by means of an organic binder, a mould and compaction at ambient temperature. The samples were then subjected to a conventional hard-metal sintering process.

The three sets of diamond-enhanced samples were prepared by introducing diamond grains into the powder blend used to make the control samples and described above. The respective proportions of diamond, tungsten carbide and cobalt were 7.2 wt %, 85.6 wt % and 7.2 wt. %. In the three sets of samples, the added diamond had respective average sizes of about 2, 20 and 70 microns. These samples were formed and conventionally sintered in the same way as the control samples and, together with the control samples, were subjected to ultra-high pressure sintering step, wherein the applied pressure and temperature was sufficient to achieve conditions at which diamond is thermodynamically stable.

The graph of FIG. 19 shows that even though diamond content is that same for all but the control article, the Young's modulus of the material increases as the added diamond grains increase in average size from about 2 to about 70 microns. The Young's modulus of the control cobalt-cemented WC article, wherein the cobalt was present at about 13 wt. %, was about 558±5 GPa, and those of the articles with two, twenty and seventy micron diamond was about 580, 595 and 660 GPa, respectively.

### Example 7

Two sets of samples of diamond-enhanced cemented tungsten carbide were made according to the invention, each set consisting of seven samples. A set of control samples was made with no added diamond according to a commercially-available hard-metal formulation: approximately 94 vol. % WC and 6 wt. % cobalt. The WC was in granular form, the average size of the grains being in the range of 1 to 3 microns. The control samples were made by a process including the steps of blending the WC grains with cobalt powder, forming the powder into a green body article by means of an organic binder, a mould and compaction at ambient temperature. The samples were then subjected to a conventional hard-metal sintering process.

The two sets of diamond-enhanced samples was prepared by introducing diamond grains into the powder blend used to make the control samples and described above. The respective proportions of diamond, tungsten carbide and cobalt were 9 wt %, 85.7 wt % and 5.4 wt. %. In the two sets of samples, the added diamond had respective average sizes of about 2 microns and 30 microns. These samples were formed and conventionally sintered in the same way as the control samples and, together with the control samples, were subjected to ultra-high pressure sintering step, wherein the applied pressure and temperature was sufficient to achieve conditions at which diamond is thermodynamically stable.

As shown in FIG. 20, the measured Young's modulus of the conventional cemented tungsten carbide control samples was 629±2 GPa, and that of the both the diamond-enhanced materials was about 712±5 GPa. These are in agreement with the predictions of the “geometric” theoretical model.

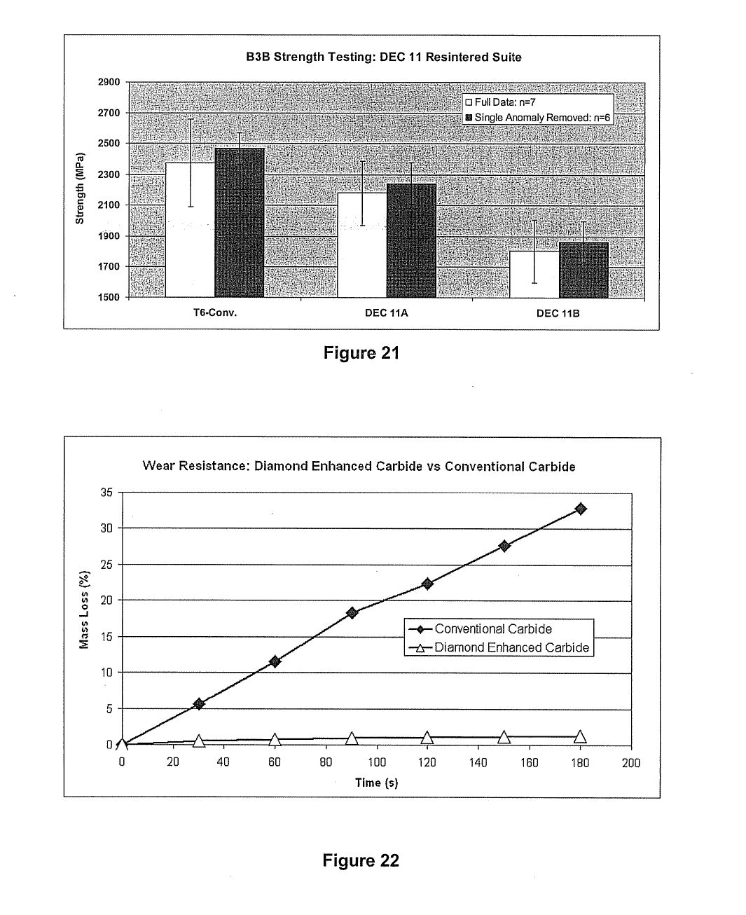

As shown in FIG. 21, the strength of the control sample was 2.5±0.1 GPa. The respective strengths of the two samples of diamond-enhanced samples made according to the invention are 2.2 and 1.9±0.15 GPa.

### Example 8

An enhanced hard-metal was produced as per examples 2-4 (i.e. diamond added as excess-C source), but this time a with 20 vol % diamond with a mean grain size of approximately 22 μm.

The enhanced hard-metal so produced exhibited a dramatically improved wear resistance over conventional non-DEC carbide.

As illustrated in FIG. 22, after a 3 minute ‘mechanical grindability’ wear test, the enhanced hard-metal material mass loss was approximately 25× less than the conventional carbide mass loss.

Details of the mechanical grindability wear test:
1.the sample (dimensions: 9 mm×7 mm×3.2 mm) is clamped against a rotating diamond wheel (D46 vitreous bond) with a normal force via a dead weight of 1.6 kg;
2. the wheel rotates at 1000 rpm, giving a surface speed at the sample of 0.9 m.s-1; and
3. the sample mass is recorded every 30 seconds for the mass loss plot shown in FIG. 22.

1. A super-hard enhanced hard-metal comprising particulate hard material and a binder and at least one formation, the formation comprising a core cluster and a plurality of satellite clusters, spaced from, surrounding and smaller than the core cluster, and the core cluster and satellite clusters each comprising a plurality of contiguous super-hard particles.

2. A hard-metal according to claim 1 wherein the super-hard particles comprise diamond.

3. A hard-metal according to claim 1 wherein each satellite cluster has an average volume of less than about 20% that of the core cluster.

4. A hard-metal according to claim 1 wherein each satellite cluster contains fewer than about 20% of the number of super-hard particles contained within the core cluster.

5. A hard-metal according to claim 1 wherein the core cluster comprises a collar or shell of super-hard particles and hard material enclosing a region containing binder material and substantially less super-hard material.

6. A hard-metal according to claim 5 wherein the region is substantially free of hard super-hard particles.

7. A hard-metal according to claim 1 wherein the core cluster comprises a super-hard particle directly bonded to a collar or shell of super-hard particles and hard material

8. A hard-metal according to claim 1 wherein the core cluster comprises a plurality of contiguous super-hard particles and hard material particles interspersed through the contiguous super-hard particles.

9. A hard-metal according to claim 1 wherein the hard material comprises a metal carbide, metal oxide or metal nitride, boron sub-oxide or boron carbide.

10. A hard-metal according to claim 1 wherein the hard material is selected from the group consisting of WC, TiC, VC, Cr3C2, Cr7C3, ZrC, Mo2C, HfC, NbC, Nb2C, TaC, Ta2C, W2C, SiC and Al4C3.

11. A hard-metal according to claim 1 wherein the binder material is a metal or metal alloy containing one or more of cobalt, iron or nickel.

12. A hard-metal according to claim 1 wherein the binder material additionally comprises an inter-metallic material including Ni3Al, Ni2Al3 and NiAl3, CoSn, NiCrP, NiCrB and NiP.

13. A hard-metal according to claim 1 wherein the volume content of the binder material is within the range 1 to 40 volume %.

14. A hard-metal according to claim 1 wherein the core cluster is at least twice the average size of each satellite clusters.

15. A hard-metal according to claim 1 wherein the super-hard particles are within the size range from about 0.1 to about 5,000 micrometers.

16. A hard-metal according to claim 1 wherein the content of super-hard material within the super-hard enhanced hard-metal is in the range from 20 to 60 volume percent (%).

17. A hard-metal according to claim 1 wherein the hard material particles are within the size range from about 0.5 to about 100 micrometers.

18. A hard-metal according to claim 1 wherein the content of hard material within the super-hard enhanced hard-metal is in the range from 20 to 80 volume percent.

19. A hard-metal according to claim 1 wherein the formation has a substantially isotropic character.

20. A hard-metal according to claim 1 which comprises a plurality of formations dispersed through the hard-metal.

21. A hard-metal according to claim 1 including substantially no graphite.

22. A method for making a super-hard enhanced hard-metal, the method including forming a green body comprising super-hard particles, particles of a hard material and at least one binder material or material that is capable of being converted into a binder material; subjecting the green body to a temperature of at least 500 degrees centigrade and a pressure at which the super-hard material is not thermodynamically stable to form a sintered body; and subjecting the sintered body to a pressure and temperature at which the super-hard material is thermodynamically stable.

23. A method according to claim 22 involving subjecting the body to a pressure of at least about 3 GPa.

24. A method according to claim 22 wherein heat treatment of the green body is carried out under an applied pressure of less than 300 Mpa.

25. An insert for a tool, the insert comprising a super-hard enhanced hard-metal according to claim 1.
